(19) United States
(12) Patent Application Publication
(10) Pub. No.: US 2025/0173584 A1
(43) Pub. Date: May 29, 2025

(54) PREDICTION MODEL FOR DEBUGGING

(71) Applicant: Truist Bank, Charlotte, NC (US)

(72) Inventor: Deepak JANKE, Charlotte, NC (US)

(73) Assignee: Truist Bank, Charlotte, NC (US)

(21) Appl. No.: 18/522,952

(22) Filed: Nov. 29, 2023

(51) Int. Cl. G06N 5/022; G06F 11/36

(52) U.S. Cl. CPC G06N 5/022; G06F 11/362

(57) ABSTRACT

Systems, apparatuses, and computer-implemented methods provide for technology that extracts textual data from a plurality of different sources in accordance with a plurality of variables, wherein the textual data is to be associated with a plurality of errors, groups the textual data into a plurality of categories, and trains an NLP prediction model based on the textual data and the plurality of categories.

### TECHNICAL FIELD

Embodiments generally relate to debugging operations. More particularly, embodiments relate to a prediction model for debugging operations.

### BACKGROUND

Debugging complex computing systems to determine root causes and resolutions can be challenging, particularly when failures are documented by large teams of information technology (IT) personnel across several different data sources. Indeed, many organizations may spend a significant amount of time and effort manually searching through technician logs, only to determine that a root cause of a given failure cannot be found.

### SUMMARY

In one embodiment, a performance-enhanced computing system comprises a network controller, a processor coupled to the network controller, and a memory coupled to the processor, the memory including a set of instructions, which when executed by the processor, cause the processor to extract textual data from a plurality of different sources in accordance with a plurality of variables, wherein the textual data is to be associated with a plurality of errors, group the textual data into a plurality of categories, and train a natural language processing (NLP) prediction model based on the textual data and the plurality of categories.

In another embodiment, at least one computer readable storage medium comprising a set of instructions, which when executed by a computing system, cause the computing system to extract textual data from a plurality of different sources in accordance with a plurality of variables, wherein the textual data is to be associated with a plurality of errors, group the textual data into a plurality of categories, and train a natural language processing (NLP) prediction model based on the textual data and the plurality of categories.

In another embodiment, a method of operating a performance-enhanced computing system comprises extracting textual data from a plurality of different sources in accordance with a plurality of variables, wherein the textual data is associated with a plurality of errors, grouping the textual data into a plurality of categories, and training a natural language processing (NLP) prediction model based on the textual data and the plurality of categories.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein;

FIG. 2 illustrates a block diagram of the mobile device of FIG. 1;

FIG. 3 illustrates a block diagram of the personal computing device of FIG. 1;

FIG. 4 illustrates a block diagram of the one or more financial institution servers of FIG. 1;

FIG. 5 shows a block diagram of an example of a debugging architecture according to an embodiment;

FIGS. 6A-6C are illustrations of examples of different sources of textual data according to an embodiment;

FIG. 7 is a flowchart of an example of a method of operating a performance-enhanced computing system according to an embodiment;

FIG. 8 is a flowchart of an example of a method of handling prediction requests according to an embodiment; and

FIG. 9 is a block diagram of an example of a performance-enhanced computing system according to an embodiment.

### DETAILED DESCRIPTION

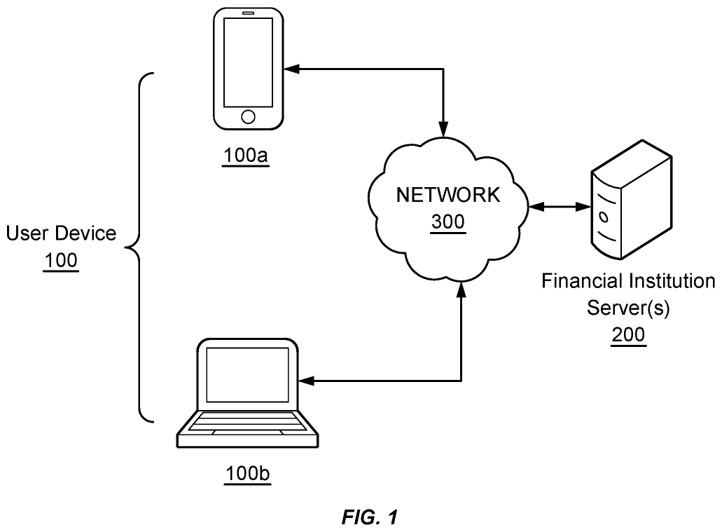

Turning to the figures, in which FIG. 1 illustrates a communication environment in which a user communicates with a financial institution. A user device 100 (100a, 100b) operating in the communication environment facilitates user access to and user management of one or more user accounts residing at one or more financial institution servers 200 of the financial institution. The communication environment includes the user device 100, the one or more financial institution servers 200, and a communications network 300 through which communication is facilitated between the user device 100 and the one or more financial institution servers 200.

In accordance with one or more embodiments, the user device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the user device 100 comprising any form of electronic device that optimizes the performance and functionality of the one or more embodiments in a manner that falls within the spirit and scope of the principles of this disclosure.

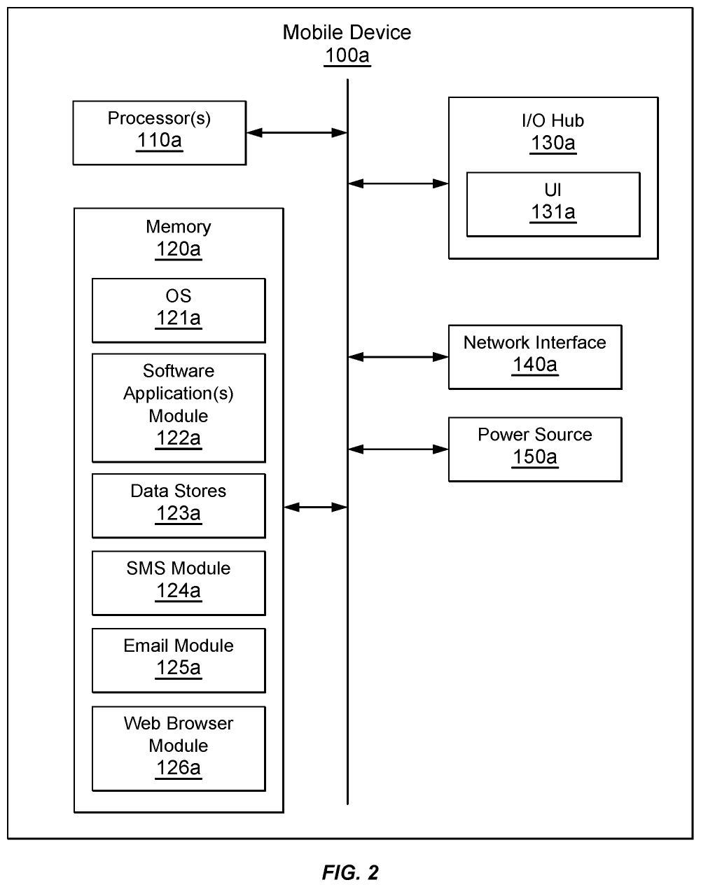

In the illustrated example embodiment of FIG. 2, the user device 100 (FIG. 1) comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause the one or more processors 110a to execute an operating system (OS) 121a and one or more software applications of a software application module 122a that reside in the memory 120a. The one or more software applications residing in the memory 120a includes, but is not limited to, a financial institution application that is associated with the financial institution servers 200 (FIG. 1) and which facilitates user access to the one or more user accounts in addition to user management of the one or more user accounts. The financial institution application comprises a mobile financial institution application that facilitates establishment of a secure connection between the mobile device 100a and the one or more financial institution servers 200 (FIG. 1).

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 123a may be a component of the one or more processors 110a, or alternatively, may be operatively connected to the one or more processors 110a for use thereby. As set forth, described, and/or illustrated herein, “operatively connected” may include direct or indirect connections, including connections without direct physical contact.

The memory 120a also includes an SMS (short messaging service) module 124a operable to facilitate user transmission and receipt of text messages via the mobile device 100a though the network 300 (FIG. 1). In one example embodiment, a user may receive text messages from the financial institution that are associated with the user access and the user management of the one or more user accounts. An email module 125a is operable to facilitate user transmission and receipt of email messages via the mobile device 100a through the network 300 (FIG. 1). In one example embodiment, a user may receive email messages from the financial institution that are associated with the user access and the user management of the one or more user accounts. A user may utilize a web browser module 126a that is operable to facilitate user access to one or more websites associated with the financial institution through the network 300 (FIG. 1).

In accordance with one or more embodiments, the mobile device 100a includes an I/O hub 130a operatively connected to other systems and subsystems of the mobile device 100a. The I/O hub 130a may include one or more of an input interface, an output interface, and a network controller to facilitate communications between the user device 100 and the server 200 (FIG. 1). The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a includes a network interface 140a operable to facilitate connection to the network 300. The mobile device 100a also includes a power source 150a that comprises a wired powered source, a wireless power source, a replaceable battery source, or a rechargeable battery source.

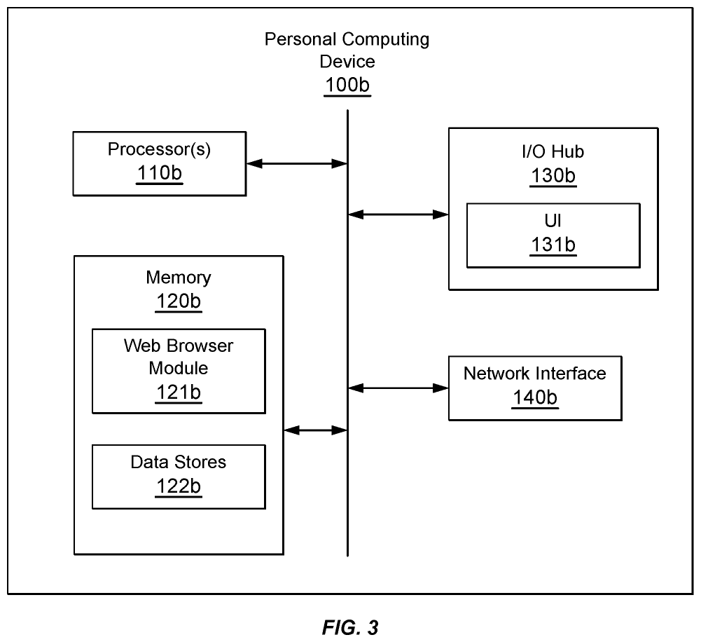

In the illustrated example embodiment of FIG. 3, the user device 100 (FIG. 1) comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110b, an I/O hub 130b, and a network interface 140b. The I/O hub 130b may include one or more of an input interface, an output interface, and a network controller to facilitate communications between the user device 100 and the server 200 (FIG. 2). The input interface and the output interface may be integrated as a single, unitary user interface 131b, or alternatively, be separate as independent interfaces that are operatively connected.

The memory 120b comprises a set of instructions of computer-executable program code. The set of instructions are executable by the one or more processors 110b to cause the one or more processors 110b to control the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122a may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110a (FIG. 2), 110b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110a (FIG. 2), 110b may comprise at least one hardware circuit (e.g., an integrated circuit) operable to carry out instructions contained in program code. In embodiments in which there is a plurality of processors, such processors may work independently from each other, or one or more processors may work in combination with each other.

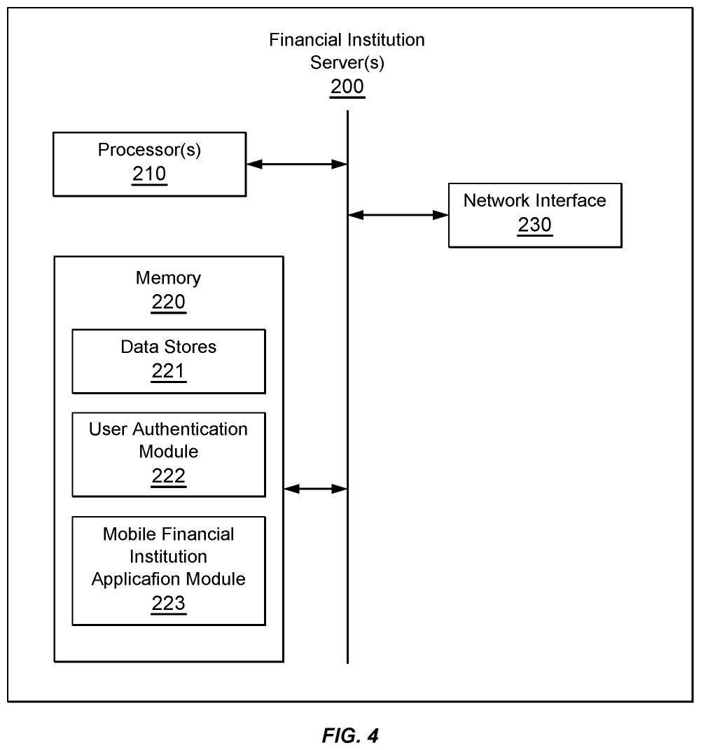

As illustrated in FIG. 4, the one or more financial institution servers 200 includes one or more processors 210, a non-transitory memory 220 operatively coupled to the one or more processors 210, and a network interface 230. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The memory 220 comprises a set of instructions of computer-executable program code. The set of instructions are executable by the one or more processors 210 in manner that facilitates control of a user authentication module 222 and a mobile financial institution application module 223 having one or more mobile financial institution applications that reside in the memory 220.

The memory 220 also includes one or more data stores 221 that are operable to store one or more types of data, including but not limited to, user account data and user authentication data. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The computer-executable program code may instruct the one or more processors 210 to cause the user authentication module 222 to authenticate a user in order to gain user access to the one or more user accounts. The user authentication module 222 may be caused to request user input user data or user identification that include, but are not limited to, user identity (e.g., user name), a user passcode, a cookie, user biometric data, a private key, a token, and/or another suitable authentication data or information.

The computer-executable program code of the one or more mobile financial institution applications of the mobile financial institution application module 223 may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 223 are operable to communicate with the user device 100 (FIG. 1) in a manner which facilitates user access to the one or more user accounts in addition to user management of the one or more user accounts based on successful user authentication.

In accordance with one or more embodiments set forth, described, and/or illustrated herein, the network 300 (FIG. 1) may comprise a wireless network, a wired network, or any suitable combination thereof. For example, the network 300 (FIG. 1) is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

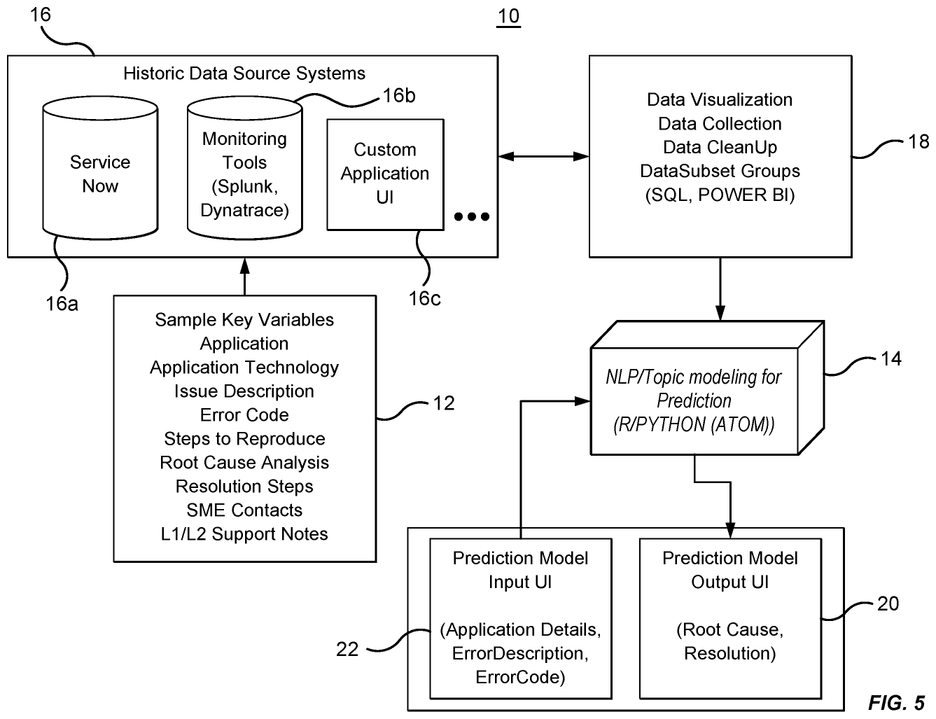

Turning now to FIG. 5, a debugging architecture 10 is shown in which a plurality of variables 12 are defined for a natural language processing (NLP) prediction model 14. In one example, the debugging architecture 10 is implemented in a server such as, for example, the financial institution service(s) 200 (FIGS. 1 and 4), already discussed. In general, the plurality of variables 12 are used to extract textual (e.g., non-numeric) data from a plurality of different sources 16 (16a-16c, e.g., historical data source systems). In the illustrated example, the plurality of variables 12 include an application name (e.g., Application A, Application B), application technology (e.g., wire transfer, automated clearing house/ACH, brokering), issue description, error code, reproduction procedure (e.g., operations/steps to reproduce the error), root cause analysis, resolution procedure (e.g., operations/steps to resolve the error), subject matter expert (SME), support notes, and so forth. Additionally, the plurality of different sources 16 may include an information technology (IT) service management system 16a (e.g., SERVICENOW), monitoring tools 16b (e.g., SPLUNK, DYNATRACE), an application user interface (UI, e.g., custom application UI) 16c, an application lifecycle management (ALM) system, code review trackers, application programming interface (API) testing tools (e.g., SOAPUI), etc., or any combination thereof.

The textual data extracted from the plurality of different sources 16 is associated with a plurality of errors and is typically authored by large teams of IT personnel over time. For example, a particular error and/or failure (e.g., broker system is down) might be encountered and documented by a first technician in the IT service management system 16a at a first moment in time (e.g., time t₀), and then encountered and documented by a second technician in the application UI 16c at a second moment in time (e.g., time t₁, six months after t₀).

An automated data visualization process 18 collects the textual data, normalizes the textual data (e.g., data clean up), and groups the textual data into a plurality of categories (e.g., data subsets). For example, if the textual data documents 100k issues, the automated data visualization process 18 might group the textual data into one hundred categories of approximately 1000 issues each. The debugging architecture 10 trains the NLP prediction model 14 based on the textual data and the plurality of categories. The categories can facilitate the training of the NLP prediction model 14 by enabling the NLP prediction model 14 to identify points of commonality between issues within the categories. In one example, the training of the NLP prediction model 14 is iterative (e.g., based on linear regression) and enables the NLP prediction model 14 to generate inference outputs 20 in response to real-time prediction requests 22, wherein the real-time prediction requests 22 identify current errors and the inference outputs 20 include root causes and/or resolution recommendations for the current errors. More particularly, the NLP prediction model 14 can be trained using an NLP text classification procedure based on key text in certain key variables. Such training may depend on the underlying data and can be determined during the data visualization process 18 or during a custom model build using some tools such as, for example, PEGA Decisioning.

The debugging architecture 10 enhances performance at least to the extent that training the NLP prediction model 14 with textual data and categories enables the NLP prediction model 14 to quantify and/or learn the meaning of varying technician notes, remarks, etc., in terms of root causes and/or resolutions. As a result, debugging latency is significantly reduced. Indeed, such an approach is particularly useful given the heterogeneous/disparate nature of the plurality of different sources 16.

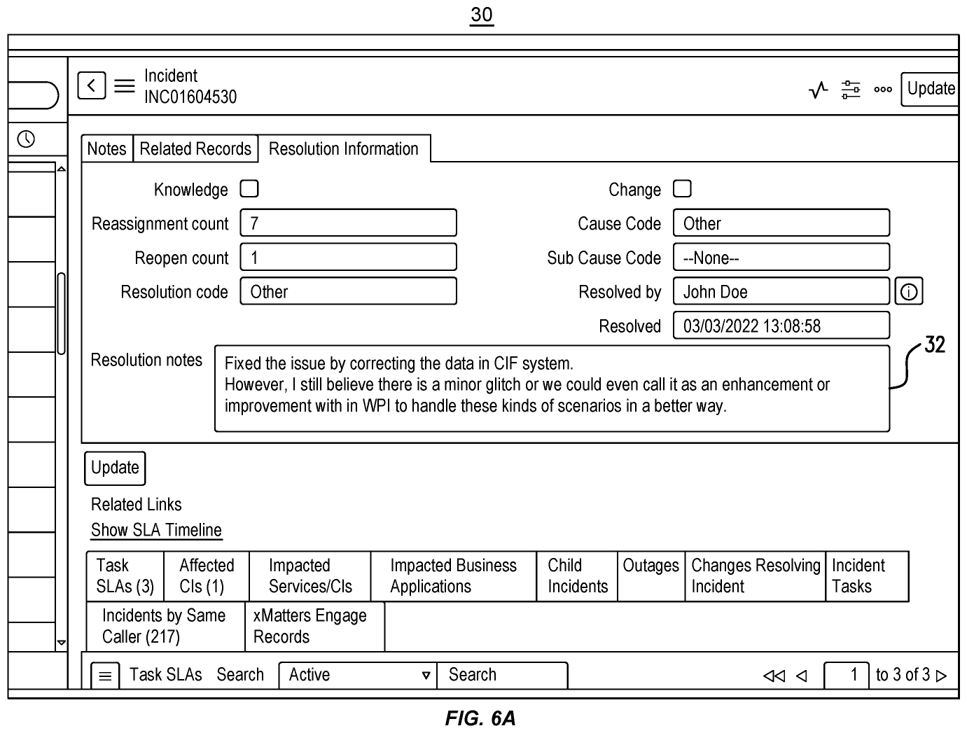

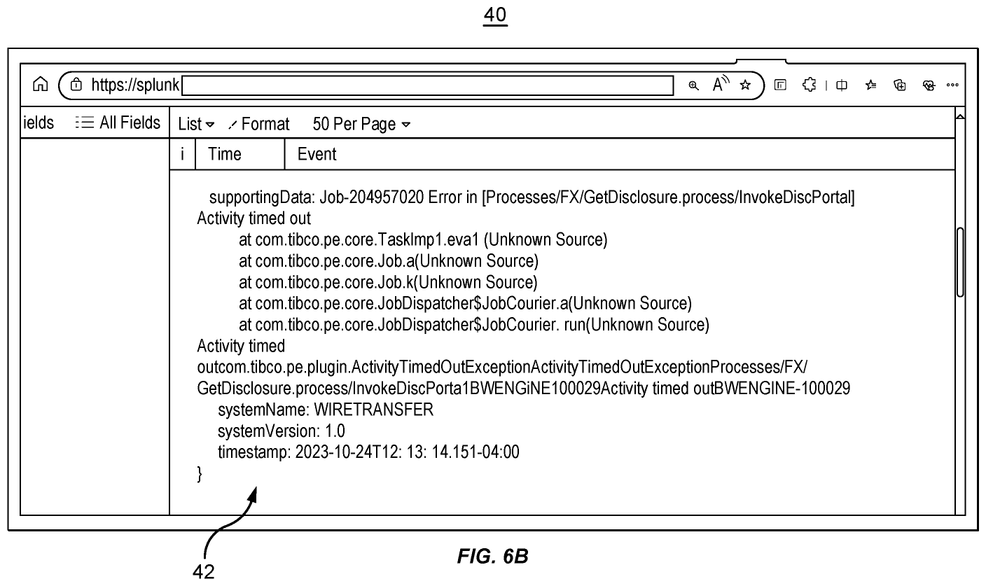

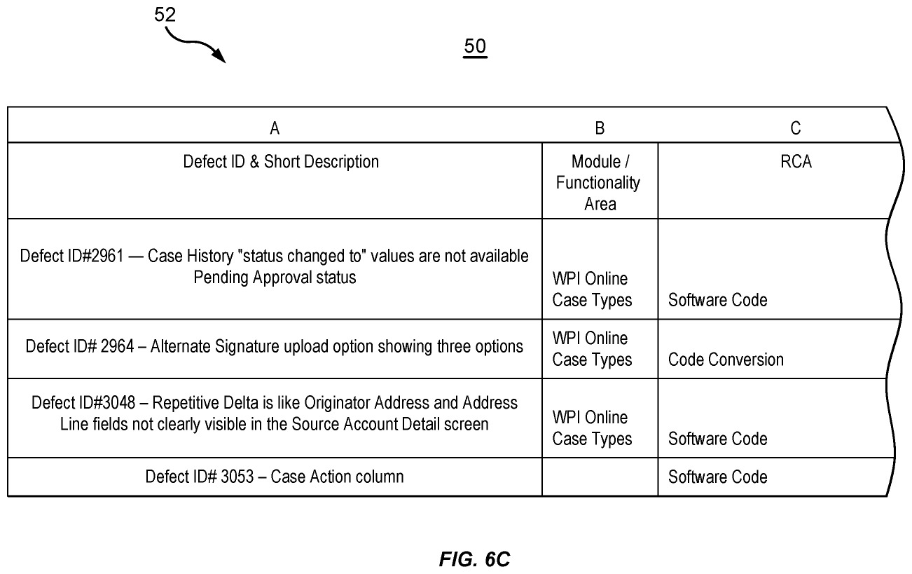

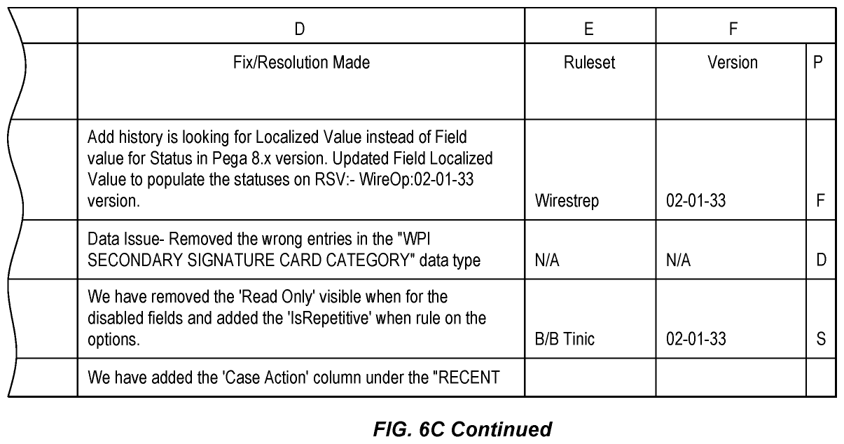

FIG. 6A shows an interface 30 to an IT service management such as, for example, the IT service management system 16a (FIG. 5), already discussed. In the illustrated example, a technician (e.g., John Doe) has documented a resolution of an error as textual data in a resolution notes field 32, wherein the resolution references a CIF (Customer Information File) system (e.g., mainframe based application that is a system of record for accounts data) and a WPI (Wire Payment Initiation, e.g., PEGA based application for wire initiation).

FIG. 6B shows an interface 40 to a monitoring tool such as, for example, the monitoring tool 16b (FIG. 5), already discussed. In the illustrated example, a wire transfer timeout error is documented as textual data in a code dump 42.

FIG. 6C shows an interface 50 to an application UI such as, for example, the application UI 16c (FIG. 5), already discussed. In the illustrated example, various errors are documented as textual data in a column 52 (e.g., Defect Identification/ID & Short Description column).

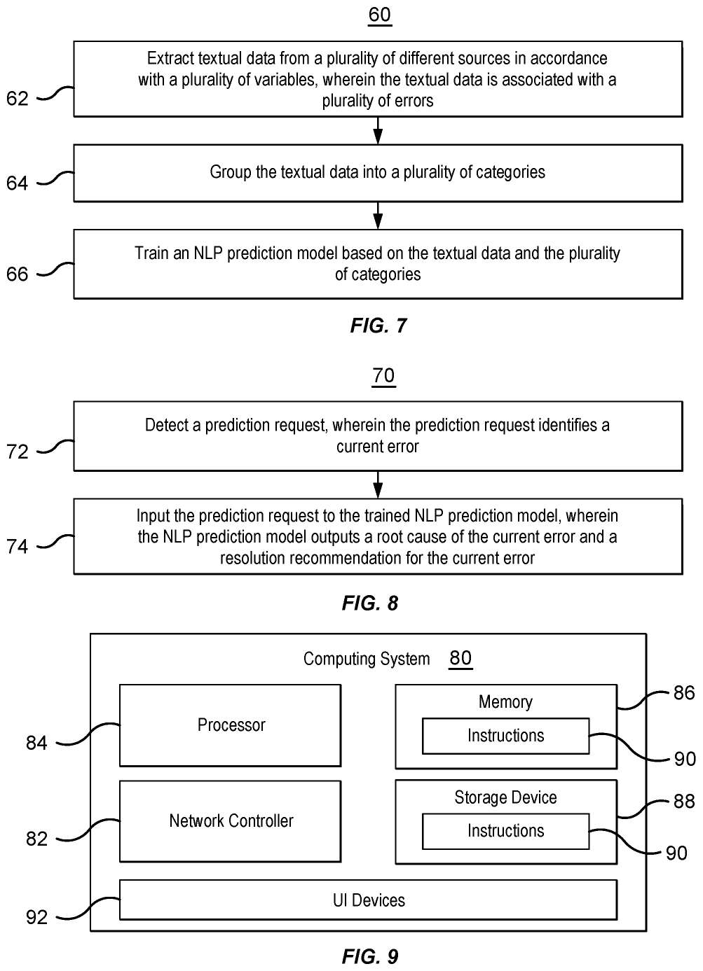

FIG. 7 shows a computer-implemented method 60 of operating a performance-enhanced computing system. The computer-implemented method 60 may generally be implemented in a server such as, for example, the financial institution server(s) 200 (FIGS. 1 and 4), already discussed. More particularly, the computer-implemented method 60 may be implemented in one or more modules as a set of logic instructions stored in a machine-or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the computer-implemented method 60 can be written in any combination of one or more programming languages, including an object oriented programming language such as JAVA, PYTHON, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 62 provides for extracting textual data from a plurality of different sources in accordance with a plurality of variables, wherein the textual data is associated with a plurality of errors. In an embodiment, the plurality of variables includes one or more of an application name, an application technology, an issue description, an error code, a reproduction procedure, a root cause analysis, a resolution procedure, an SME, or support notes. Additionally, the plurality of different sources includes an IT service management system, a monitoring tool, an application UI, etc., or any combination thereof. Block 64 groups the textual data into a plurality of categories and block 66 trains an NLP prediction model (e.g., via iterative linear regression) based on the textual data and the plurality of categories.

The method 60 therefore enhances performance at least to the extent that training the NLP prediction model with textual data and categories enables the NLP prediction model to quantify and/or learn the meaning of varying technician notes, remarks, etc., in terms of root causes and/or resolutions. As a result, debugging latency is significantly reduced. Indeed, such an approach is particularly useful given the heterogeneous/disparate nature of the plurality of different sources.

FIG. 8 shows a computer-implemented method 70 of handling prediction requests. The computer-implemented method 70 may generally be implemented in a server such as, for example, the financial institution server(s) 200 (FIGS. 1 and 4), already discussed. More particularly, the computer-implemented method 70 may be implemented in one or more modules as a set of logic instructions stored in a machine-or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 72 provides for detecting a prediction request, wherein the prediction request identifies a current error (e.g., broker system is down). Block 74 inputs the prediction request to the trained NLP prediction model, wherein the NLP prediction model outputs a root cause of the current error. Block 74 may also output a resolution recommendation for the current error. In an embodiment, block 74 includes operating the NLP prediction model to generate/output the root cause and/or resolution recommendation.

FIG. 9 shows a server 80 (e.g., computing system) that includes a network controller 82 (e.g., wired, wireless), UI devices 92 (e.g., display, keyboard, mouse, etc.), a processor 84 (e.g., host processor, central processing unit/CPU), a volatile memory 86 (DRAM), and mass storage 88 (e.g., storage device, flash memory, optical disc, hard disk drive/HDD, solid state drive/SDD). In the illustrated example, the processor 84 executes instructions 90 retrieved from the volatile memory 86 and/or the mass storage 88 to conduct one or more aspects of the computer-implemented method 60 (FIG. 7) and/or the computer-implemented method 70 (FIG. 8), already discussed. Thus, execution of the instructions 90 causes the processor 84 to extract textual data from a plurality of different sources in accordance with a plurality of variables, wherein the textual data is to be associated with a plurality of errors, group the textual data into a plurality of categories, and train an NLP prediction model based on the textual data and the plurality of categories.

The server 80 is therefore considered performance-enhanced at least to the extent that training the NLP prediction model with textual data and categories enables the NLP prediction model to quantify and/or learn the meaning of varying technician notes, remarks, etc., in terms of root causes and/or resolutions. As a result, debugging latency is significantly reduced. Indeed, such an approach is particularly useful given the heterogeneous/disparate nature of the plurality of different sources.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A computing system comprising:
a network controller;
a processor coupled to the network controller; and
a memory coupled to the processor, the memory including a set of instructions, which when executed by the processor, cause the processor to:
extract textual data from a plurality of different sources in accordance with a plurality of variables, wherein the textual data is to be associated with a plurality of errors,
group the textual data into a plurality of categories, and
train a natural language processing (NLP) prediction model based on the textual data and the plurality of categories.

2. The computing system of claim 1, wherein the plurality of different sources is to include an information technology service management system.

3. The computing system of claim 1, wherein the plurality of different sources is to include a monitoring tool.

4. The computing system of claim 1, wherein the plurality of different sources is to include an application user interface.

5. The computing system of claim 1, wherein the plurality of variables is to include one or more of an application name, an application technology, an issue description, an error code, a reproduction procedure, a root cause analysis, a resolution procedure, a subject matter expert, or support notes.

6. The computing system of claim 1, wherein the instructions, when executed, further cause the processor to:
detect a prediction request, wherein the prediction request identifies a current error, and
input the prediction request to the trained NLP prediction model, wherein the NLP prediction model is to output a root cause of the current error.

7. The computing system of claim 6, wherein the NLP prediction model is to further output a resolution recommendation for the current error.

8. At least one computer readable storage medium comprising a set of instructions, which when executed by a computing system, cause the computing system to:
extract textual data from a plurality of different sources in accordance with a plurality of variables, wherein the textual data is to be associated with a plurality of errors;
group the textual data into a plurality of categories; and
train a natural language processing (NLP) prediction model based on the textual data and the plurality of categories.

9. The at least one computer readable storage medium of claim 8, wherein the plurality of different sources is to include an information technology service management system.

10. The at least one computer readable storage medium of claim 8, wherein the plurality of different sources is to include a monitoring tool.

11. The at least one computer readable storage medium of claim 8, wherein the plurality of different sources is to include an application user interface.

12. The at least one computer readable storage medium of claim 8, wherein the plurality of variables is to include one or more of an application name, an application technology, an issue description, an error code, a reproduction procedure, a root cause analysis, a resolution procedure, a subject matter expert, or support notes.

13. The at least one computer readable storage medium of claim 8, wherein the instructions, when executed, further cause the computing system to:
detect a prediction request, wherein the prediction request identifies a current error; and
input the prediction request to the trained NLP prediction model, wherein the NLP prediction model is to output a root cause of the current error.

14. The at least one computer readable storage medium of claim 13, wherein the NLP prediction model is to further output a resolution recommendation for the current error.

15. A method comprising:
extracting textual data from a plurality of different sources in accordance with a plurality of variables, wherein the textual data is associated with a plurality of errors;
grouping the textual data into a plurality of categories; and
training a natural language processing (NLP) prediction model based on the textual data and the plurality of categories.

16. The method of claim 15, wherein the plurality of different sources includes an information technology service management system.

17. The method of claim 15, wherein the plurality of different sources includes a monitoring tool.

18. The method of claim 15, wherein the plurality of different sources includes an application user interface.

19. The method of claim 15, wherein the plurality of variables includes one or more of an application name, an application technology, an issue description, an error code, a reproduction procedure, a root cause analysis, a resolution procedure, a subject matter expert, or support notes.

20. The method of claim 15, further including:
detecting a prediction request, wherein the prediction request identifies a current error; and
inputting the prediction request to the trained NLP prediction model, wherein the NLP prediction model outputs a root cause of the current error and a resolution recommendation for the current error.
